(19) United States
(12) Patent Application Publication
(10) Pub. No.: US 2010/0249009 A1
(43) Pub. Date: Sep. 30, 2010

(54) Cleaning Agents

(76) Inventors: Thomas Holderbaum, Hilden (DE); Johannes Zipfel, Dusseldorf (DE)

Correspondence Address: Henkel Corporation, 10 Finderne Avenue, Suite B, Bridgewater, NJ, 08807, US

(21) Appl. No.: 12/796,690

(22) Filed: Jun. 9, 2010

Related U.S. Application Data
(63) Continuation of application No. PCT/EP2008/064969, filed on Nov. 5, 2008.

(30) Foreign Application Priority Data
Dec. 11, 2007 (DE) 10 2007 059 970.8

(51) Int. Cl. C11D 3/395

(52) U.S. Cl. 510/224; 510/220; 510/228

(57) ABSTRACT

Two- or multi-phase detergents or cleaning agents which comprise a) a bleaching agent, b) a bleach activator, c) a bleach catalyst, selected from the group of bleach boosting transition metal salts and transition metal complexes, the bleaching agent a) being present in a separate phase of the detergents or cleaning agents separate from components b) and c). The detergents or cleaning agents according to the invention are characterized in that the bleach activator b) is used in particulate form and the bleach activator particles comprise, based on their total weight, a percentage in bleach activator of more than 80% by weight. The detergents or cleaning agents according to the invention have a good cleaning power on bleachable soilings.

### CROSS REFERENCE TO RELATED APPLICATIONS

The present application is a continuation of International Application No. PCT/EP2008/064969 filed 5 Nov. 2008, which claims priority to German Patent Application No. 10 2007 059 970.8 filed 11 Dec. 2007.

The present patent application describes washing or cleaning agents, particularly cleaning agents for automatic cleaning of dishes. The present application in particular provides bi- or multiphase automatic dishwashing agents containing bleach catalysts.

Today, more stringent requirements are often applied to machine washed dishes than to hand washed dishes. For example, a dish which first appears to be completely clean of food residues is not considered clean if it still exhibits discoloration after automatic dishwashing due to, for example, deposition of vegetable dyes onto the surface of the dish.

To achieve spotless dishes, bleaching agents are used in automatic dishwashing agents. To activate these bleaching agents and achieve improved bleaching action at temperatures of 60° C. and below, automatic dishwashing agents generally additionally contain bleach activators or bleach catalysts, with bleach catalysts having proven particularly effective.

European patent application EP 481 793 A1 (Unilever) discloses cleaning agent tablets containing sodium percarbonate which, according to the teaching of said application, is preferably formulated separately from other components detrimental to the stability thereof, for example, in a separate layer.

Bleach catalysts are used in automatic dishwashing agents preferably in the form of premanufactured granules. For example, European patents EP 458 397 B1 (Unilever), EP 458 398 B1 (Unilever) and EP 530 870 B1 (Unilever) describe bleach catalysts based on various manganese-containing transition metal complexes.

Methods for producing bleach catalyst granules are disclosed in published patent applications EP 544 440 A2 (Unilever) and WO 95/06710 A1 (Unilever). A distinguishing feature of the method described therein is the use of large quantities of binder, optionally used in the form of melts, said procedure involving cooling and/or drying stages which require the use of additional apparatuses such as fluidized bed installations.

Still, despite their undisputed bleaching action, use of bleach catalysts cannot be considered satisfactory in every respect for a person skilled in the art. For instance, even with use of bleach catalysts, unexpectedly poor bleaching action is frequently observed, particularly in low-alkali, for example, phosphate-free automatic dishwashing agents. Furthermore, storage stability of cleaning agents containing bleach catalysts frequently leaves something to be desired.

In the light of this initial situation, the present application provides an automatic dishwashing agent which exhibits improved cleaning performance, particularly on bleachable soiling.

It has surprisingly been found that the bleaching action of automatic dishwashing agents can be increased by formulating active ingredient combinations of bleaching agent, bleach activator and bleach catalyst in bi- or multiphase dispensing units with an optimized phase split, and by using specific bleach activator granules with an elevated bleach activator content.

The present application accordingly firstly provides a bi- or multiphase washing or cleaning agent comprising—
a) a bleaching agent,
b) a bleach activator, and
c) a bleach catalyst chosen from bleach-boosting transition metal salts and transition metal complexes,
   wherein bleaching agent a) is present and separated from components b) and c) in a separate phase of the washing or cleaning agent, wherein the bleach activator b) is in particulate form and has, relative to total weight of the particles, a content of bleach activator of 80 wt. % or greater.

As stated above, in the bi- or multiphase washing or cleaning agents according to the invention, bleaching agent a) is present and separated from components b) and c) in a separate phase of the washing or cleaning agent. The application accordingly provides bi- or multiphase washing or cleaning agents wherein the total quantity of bleaching agent a) is present in a separate phase separately from the total quantity of components b) and c).

The application accordingly preferably provides—

Biphasic washing or cleaning agents comprising
a) a bleaching agent
b) a bleach activator
c) a bleach catalyst chosen from bleach-boosting transition metal salts and transition metal complexes,
wherein bleaching agent a) is present and separated from components b) and c) in a separate phase of the washing or cleaning agent, wherein bleach activator b) is in particulate form and the bleach activator particles have, relative to their total weight, a content of bleach activator of 80 wt. % or greater.

Triphasic washing or cleaning agents comprising
a) a bleaching agent
b) a bleach activator
c) a bleach catalyst chosen from bleach-boosting transition metal salts and transition metal complexes,
wherein bleaching agent a) is present and separated from components b) and c) in a separate phase of the washing or cleaning agent, wherein bleach activator b) is used in particulate form and the bleach activator particles have, relative to their total weight, a content of bleach activator of 80 wt. % or greater.

Tetraphasic washing or cleaning agents comprising
a) a bleaching agent
b) a bleach activator
c) a bleach catalyst chosen from bleach-boosting transition metal salts and transition metal complexes,
wherein bleaching agent a) is present and separated from components b) and c) in a separate phase of the washing or cleaning agent, wherein bleach activator b) is used in particulate form and the bleach activator particles have, relative to their total weight, a content of bleach activator of 80 wt. % or greater.

According to the invention, multiphase washing or cleaning agents contain as a first component a bleaching agent, with oxygen bleaching agents being preferred. Among those compounds acting as bleaching agents which release H₂O₂ in water, sodium percarbonate, sodium perborate tetrahydrate and sodium perborate monohydrate are particularly significant. Further usable bleaching agents include peroxypyrophosphates, citrate perhydrates and H₂O₂-releasing per-acidic salts or per-acids, such as perbenzoates, peroxophthalates, diperazelaic acid, phthaloimino per-acid or diperdodecanedioic acid. Organic bleaching agents may also be used. Typical organic bleaching agents include diacyl peroxides such as dibenzoyl peroxide. Further typical organic bleaching agents are peroxy acids, for example, alkylperoxy acids and arylperoxy acids.

Preferred bi- or multiphase washing or cleaning agents have a bleaching agent a) which is an oxygen bleaching agent, preferably sodium percarbonate, particularly preferably a coated sodium percarbonate.

The weight proportion of bleaching agent a), relative to total weight of the washing or cleaning agent, is preferably from 2 to 30 wt. %, more preferably from 4 to 20 wt. %, and particularly from 6 to 15 wt. %.

Bi- or multiphase washing or cleaning agents according to the invention contain bleach activators as a second component. Useful bleach activators are compounds which, under perhydrolysis conditions, yield aliphatic peroxycarboxylic acids with preferably 1 to 10 C atoms, particularly 2 to 4 C atoms, and/or optionally substituted perbenzoic acid. Suitable substances are those which bear O- and/or N-acyl groups having the stated number of C atoms and/or optionally substituted benzoyl groups. Polyacylated alkylenediamines are preferred, tetraacetylethylenediamine (TAED) having proved particularly suitable.

Bi- or multiphase washing or cleaning agents are preferred wherein the bleach activator b) is a bleach activator from the group of acetylated amines, preferably tetraacetylethylenediamine (TAED).

These bleach activators, in particular TAED, are preferably used in quantities of up to 10 wt. %, particularly 0.1 wt. % to 10 wt. %, more particularly 0.5 to 8 wt. % and particularly preferably 1.0 to 6 wt. %.

Bi- or multiphase washing or cleaning agents are preferred wherein the amount of bleach activator b) by weight, relative to total weight of the washing or cleaning agent, is from 0.1 to 10 wt. %, preferably from 0.5 to 8 wt. % and in particular from 1.0 to 6 wt. %.

Bleach activator granules used according to the invention preferably have a bleach activator content of 80 wt. % or greater, relative to total weight of the granules. Regarding the above-described bleaching action, it has been found advantageous to have the highest possible bleach activator content in the granules.

Preferred bi- or multiphase washing or cleaning agents according to the invention contain the bleach activator b) in the form of bleach activator granules which, relative to the total weight of the granules, have a bleach activator content of 85 wt. % or greater, preferably 90 wt. % or greater, particularly preferably 95 wt. % or greater, and in particular 97 wt. % or greater.

Regarding other active ingredients and auxiliaries present in the bleach activator granules b) in addition to the bleach activator, it has proven advantageous to limit the content of polymeric granulation auxiliaries and stabilizers.

Polymeric granulation auxiliaries include natural, but in particular synthetic, organic polymers such as polymeric polycarboxylates or polymeric polysulfonates. Stabilizers in particular include phosphonates described in greater detail below.

Preferred bi- or multiphase washing or cleaning agents according to the invention contain the bleach activator b) in the form of bleach activator granules having, relative to the total weight of the granule, 20 wt. % or less, preferably 15 wt. % or less, particularly preferably 10 wt. % or less, and in particular 5 wt. % or less of a polymeric granulation auxiliary.

Preferred bi- or multiphase washing or cleaning agents according to the invention contain the bleach activator b) in the form of bleach activator granules having, relative to the total weight of the granule, 20 wt. % or less, preferably 15 wt. % or less, particularly preferably 10 wt. % or less, and in particular 5 wt. % or less of stabilizing additives.

In addition to bleach activator granules containing bleach activator in an amount of 80 wt. % or greater, the bi- or multiphase washing or cleaning agents can also contain bleach activator granules having less than 80 wt. % of bleach activator; however, the proportion of these bleach activator granules having less than 80 wt. % of bleach activator in the bi- or multiphase washing or cleaning agents is preferably limited. Preferred bi- or multiphase washing or cleaning agents contain, relative to total weight of the agent, 4 wt. % or less, preferably 2 wt. % or less, more preferably 1 wt. % or less, and particularly no bleach activator in particulate form having, relative to total weight of the particulate, a content of bleach activator of less than 80 wt. %.

In addition to conventional bleach activators, washing or cleaning agents according to the invention contain at least one bleach catalyst c) as a third component. These substances comprise bleach-boosting transition metal salts or transition metal complexes such as Mn, Fe, Co, Ru or Mo salen complexes or carbonyl complexes. Mn, Fe, Co, Ru, Mo, Ti, V and Cu complexes with nitrogenous tripod ligands and Co, Fe, Cu and Ru amine complexes can also be used as bleach catalysts.

Manganese complexes in oxidation state II, III, IV or IV preferably containing one or more macrocyclic ligand(s) with N, NR, PR, O and/or S donor functions are particularly preferentially used. Ligands having nitrogen donor functions are preferably used. It is particularly preferred to use bleach catalyst(s) in agents according to the invention which contain 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN) as the macromolecular ligand. Suitable manganese complexes include [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂ and [Mn^{IV}₂(μ-O)₃(Me/Me-TACN)₂](PF₆)₂ (OAc═OC(O)CH₃).

Automatic dishwashing agents containing a bleach catalyst chosen from bleach-boosting transition metal salts and transition metal complexes, preferably from complexes of manganese with 1,4,7-trimethyl-1,4,7-triazacyclononane (Me₃-TACN) or 1,2,4,7-tetramethyl-1,4,7-triazacyclononane (Me₄-TACN), are preferred according to the invention since the above bleach catalysts can bring about a significant improvement in the cleaning result.

Bi- or multiphase washing or cleaning agents wherein the bleach catalyst c) is a complex of manganese, preferably from the group of complexes of manganese with 1,4,7-trimethyl-1,4,7-triazacyclononane (Me₃-TACN) or 1,2,4,7-tetramethyl-1,4,7-triazacyclononane (Me₄-TACN) are preferred according to the invention.

The above-mentioned bleach-boosting transition metal complexes, particularly those with Mn and Co central atoms, can be used in conventional quantities, preferably in an amount of up to 5 wt. %, particularly from 0.0025 wt. % to 1 wt. %, and particularly preferably from 0.01 wt. % to 0.30 wt. %, based on total weight of the agents containing bleach catalyst. In certain cases, however, more bleach catalyst can also be used.

Bi- or multiphase washing or cleaning agents containing bleach catalyst c) in an amount, based on total weight of the washing or cleaning agent, from 0.001 to 3.0 wt. %, preferably from 0.01 to 2.0 wt. %, and particularly from 0.01 to 1.0 wt. %, are preferred according to the invention.

Some example formulations of preferred bi- or multiphase washing or cleaning agents may be found in the following tables—

(Unless otherwise stated, the weight amounts listed in this and all following tables represent the total amounts of those components present in the bi- or multiphase washing or cleaning agent.)

| | Formulation 1 | Formulation 2 | Formulation 3 | Formulation 4 |
|---|---|---|---|---|
| Ingredient | [wt. %] | [wt. %] | [wt. %] | [wt. %] |
| Oxygen bleaching agent [1]* | 2 to 30 | 4 to 20 | 4 to 20 | 6 to 15 |
| Bleach activator^{a} [≠1]** | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |

^{a}Unless stated otherwise, in this and all following tables the term “bleach activator” refers to bleach activators in particulate form which, relative to the total weight of the particulate, have a bleach activator content of above 80 wt. %
*[1] = phase 1 (in this and all following tables)
**[≠1] = phase which does not comprise phase 1 (in this and all following tables)

| | Formulation 5 | Formulation 6 | Formulation 7 | Formulation 8 |
|---|---|---|---|---|
| Ingredient | [wt. %] | [wt. %] | [wt. %] | [wt. %] |
| Sodium percarbonate [1] | 2 to 30 | 4 to 20 | 4 to 20 | 6 to 15 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |

| | Formulation 9 | Formulation 10 | Formulation 11 | Formulation 12 |
|---|---|---|---|---|
| Ingredient | [wt. %] | [wt. %] | [wt. %] | [wt. %] |
| Sodium percarbonate [1] | 2 to 30 | 4 to 20 | 4 to 20 | 6 to 15 |
| TAED [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |

| | Formulation | Formulation 14 | Formulation 15 | Formulation 16 |
|---|---|---|---|---|
| Ingredient | 13 [wt. %] | [wt. %] | [wt. %] | [wt. %] |
| Sodium percarbonate [1] | 2 to 30 | 4 to 20 | 4 to 20 | 6 to 15 |
| TAED [≠1] | 0.1 to 10 | 0.5 to 8 | 0.5 to 8 | 1 to 6 |
| Mn-Me₃-TACN complex [≠1] | 0.001 to 3 | 0.001 to 3 | 0.01 to 2 | 0.01 to 1.0 |

In addition to the previously described ingredients, agents according to the invention can include further substances with a washing or cleaning action, preferably builders, surfactants, polymers, enzymes, glass corrosion inhibitors, corrosion inhibitors, disintegration auxiliaries, fragrances and/or perfume carriers. These preferred ingredients are described in greater detail below.

Builders include zeolites, silicates, carbonates, organic cobuilders and, where there is no environmental restriction against their use, also phosphates.

Crystalline layered silicates according to general formula NaMSix₂ₓ₊₁.yH₂O, wherein M is sodium or hydrogen, x is a number from 1.9 to 22, preferably from 1.9 to 4, with particularly preferred values for x being 2, 3 or 4, and y is a number from 0 to 33, preferably from 0 to 20, are preferentially used.

Washing or cleaning agents preferably contain a proportion by weight of a crystalline layered silicate according to the formula NaMSix₂₊₁.yH₂O in an amount of from 0.1 to 20 wt. %, preferably of from 0.2 to 15 wt. % and in particular of from 0.4 to 10 wt. %, based on total weight of these agents.

Amorphous sodium silicates can be used having an Na₂O:SiO₂ modulus of 1:2 to 1:3.3, preferably of 1:2 to 1:2.8 and in particular of 1:2 to 1:2.6, which are preferably dissolution-retarded and exhibit secondary washing characteristics.

Preferred washing or cleaning agents contain no water-insoluble aluminum silicates such as natural or synthetic zeolites used for water softening.

For the purposes of the present invention, preferably this/these silicate(s), preferably alkali metal silicates, particularly preferably crystalline or amorphous alkali metal disilicates, are present in washing or cleaning agents in amounts of 3 to 60 wt. %, preferably 8 to 50 wt. % and particularly 20 to 40 wt. %, based on total weight of the washing or cleaning agent.

Generally known phosphates can also be used as builder substances, provided that such use should not be avoided on environmental grounds. Among the numerous commercially obtainable phosphates, alkali metal phosphates have the greatest significance in the washing and cleaning agents industry, with pentasodium or pentapotassium triphosphate (sodium or potassium tripolyphosphate) being particularly preferred.

If, for the purposes of the present application, phosphates are used in the washing or cleaning agents, preferred agents contain this/these phosphate(s), preferably alkali metal phosphate(s), particularly preferably pentasodium or pentapotassium triphosphate (sodium or potassium tripolyphosphate), in quantities of 5 to 80 wt. %, preferably 15 to 75 wt. % and in particular 20 to 70 wt. %, based on total weight of the washing or cleaning agent.

Washing or cleaning agents according to the invention can contain at least one polymer containing acid groups acting as a water-softening agent as a further preferred component. The polymer containing acid groups comprises at least one monomer containing acid groups and optionally further nonionic, preferably hydrophobic, monomer(s).

The amount of this polymer or polymers, based on total weight of the automatic dishwashing agent, is preferably from 0.1 to 30 wt. %, more preferably from 0.5 to 25 wt. %, and particularly from 1.0 to 20 wt. %.

Washing or cleaning agents containing 0.1 to 30 wt. %, preferably 0.5 to 25 wt. % and in particular 1.0 to 20 wt. %, based on total weight of the agent, of copolymer(s) comprising:
i) at least one monomer containing acid groups, and
ii) optionally, further nonionic, preferably hydrophobic, monomer(s), are preferred according to the invention.

Concerning improved bleaching performance, copolymers which have proven to be particularly effective are those in which monomer i) contains acid groups comprising a carboxylic acid group and/or a sulfonic acid group.

Unsaturated carboxylic acids i) used with particular preference in these special copolymers (c) include unsaturated carboxylic acids of the formula R¹(R²)C═C(R³)COOH, wherein R¹ to R³ are mutually and independently —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH as defined above or are —COOH or —COOR⁴, R⁴ being a saturated or unsaturated, straight-chain or branched hydrocarbon residue with 1 to 12 carbon atoms.

Particularly preferred unsaturated carboxylic acids include acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylenemalonic acid, sorbic acid, cinnamic acid or mixtures thereof.

In a preferred embodiment, in addition to at least one monomer containing carboxylic acid groups, the copolymers further comprises at least one additional ionic monomer.

A first group of preferred washing or cleaning agents contain copolymer(s) comprising—

i) monomers from the group of mono- or polyunsaturated carboxylic acids, and

ii) optionally, further nonionic, preferably hydrophobic, monomer(s).

A second group of preferred washing or cleaning agents accordingly contain copolymer(s) comprising—

i) monomers from the group of mono- or polyunsaturated sulfonic acids, and

ii) optionally, further nonionic, preferably hydrophobic, monomer(s).

These preferred copolymers containing sulfonic acid groups contain as monomer i) monomers preferably contain sulfonic acid groups according to the formula R⁵(R⁶)C═C(R⁷)—X—SO₃H, wherein R⁵ to R⁷ are mutually and independently —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH, or are —COOH or —COOR⁴, R⁴ being a saturated or unsaturated, straight-chain or branched hydrocarbon residue with 1 to 12 carbon atoms, and X is an optionally present spacer group chosen from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Preferred among these monomers are those of the formulae—

H₂C═CH—X—SO₃H

H₂C═C(CH₃)—X—SO₃H

HO₃S—X—(R⁶)C═C(R⁷)—X—SO₃H,

wherein R⁶ and R⁷ are each mutually and independently —H, —CH₃, —CH₂CH₃, —CH₂CH₂CH₃, or —CH(CH₃)₂, and X is an optionally present spacer group chosen from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Particularly preferred monomers containing sulfonic acid groups include 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and mixtures of the stated acids or the water-soluble salts thereof.

Sulfonic acid groups can be present in the polymers in partially or entirely neutralized form (i.e., the acidic hydrogen atom of the sulfonic acid group can be replaced in some or all of the sulfonic acid groups with metal ions, preferably alkali metal ions and in particular with sodium ions).

Preferably, copolymers containing partially or completely neutralized sulfonic acid groups are used.

In copolymers containing monomers only from groups i) and ii), the monomer distribution of the copolymers preferably used according to the invention can be 5 to 95 wt. % of i) or ii), particularly preferably 50 to 90 wt. % of monomer from group i) and 10 to 50 wt. % of monomer from group ii), based on weight of the polymer.

Molar mass of sulfo copolymers preferably used according to the invention can be varied in order to tailor the properties of the polymers to the desired intended application. Preferred automatic dishwashing agents include copolymers have molar masses of 2000 to 200,000 gmol⁻¹, preferably of 4000 to 25,000 gmol⁻¹ and in particular of 5000 to 15,000 gmol⁻¹.

In a first preferred embodiment, in addition to at least one monomer containing sulfonic acid groups, the copolymers furthermore comprise at least one additional ionic monomer.

Polymers containing acid groups preferably contain as further nonionic, preferably hydrophobic monomer(s), monomers of the general formula R¹(R²)C═C(R³)—X—R⁴, wherein R¹ to R³ are mutually and independently —H, —CH₃ or —C₂H₅, X as an optionally present spacer group chosen from —CH₂—, —C(O)O— and —C(O)—NH—, and R⁴ is a straight-chain or branched saturated alkyl residue with 2 to 22 carbon atoms or is an unsaturated, preferably aromatic residue with 6 to 22 carbon atoms.

Particularly preferred unsaturated hydrocarbon residues include butene, isobutene, pentene, 3-methylbutene, 2-methylbutene, cyclopentene, hexene, 1-hexene, 2-methyl-1-pentene, 3-methyl-1-pentene, cyclohexene, methylcyclopentene, cycloheptene, methylcyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethylcyclohexyne, 1-octene, α-olefins with 10 or more carbon atoms such as 1-decene, 1-dodecene, 1-hexadecene, 1-octadecene and C₂₂-α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethyl-hexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acrylamide or mixtures thereof.

Some example formulations of preferred bi- or multiphase washing or cleaning agents containing polymer ingredients may be found in the following tables—

| | Formulation | Formulation 18 | Formulation 19 | Formulation 20 |
|---|---|---|---|---|
| Ingredient [phase] | 17 [wt. %] | [wt. %] | [wt. %] | [wt. %] |
| Oxygen bleaching agent [1] | 2 to 30 | 4 to 20 | 4 to 20 | 6 to 15 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |
| Polymer containing acid | 0.1 to 30 | 0.5 to 25 | 1 to 20 | 1 to 20 |
| groups* | | | | |

*Copolymer(s) comprising
i) at least one monomer containing acid groups
ii) optionally further nonionic, preferably hydrophobic monomer(s) as a component of phase [1] and/or one or more further phases.

Alkalinity donors are further builders. Substances considered as alkalinity donors include alkali metal hydroxides, alkali metal carbonates, alkali metal hydrogencarbonates, alkali metal sesquicarbonates, the stated alkali metal silicates, alkali metal metasilicates, and mixtures of the above-mentioned substances, with alkali metal carbonates, particularly sodium carbonate, sodium hydrogencarbonate or sodium sesquicarbonate preferably being used for the purposes of the present invention. A builder system containing a mixture of tripolyphosphate and sodium carbonate is particularly preferred. A builder system containing a mixture of tripolyphosphate and sodium carbonate and sodium disilicate is likewise particularly preferred. Due to their low level of chemical compatibility with other ingredients in washing or cleaning agents compared to other builder substances, alkali metal hydroxides are preferably used in small quantities, preferably in quantities of 10 wt. % or less, preferably 6 wt. % or less, particularly preferably 4 wt. % or less, and in particular 2 wt. % or less, based on total weight of the washing or cleaning agent. Particularly preferred agents are those containing 0.5 wt. % or less, and particularly no alkali metal hydroxides, based on total weight of the agent.

It is particularly preferred to use carbonate(s) and/or hydrogencarbonate(s), preferably alkali metal carbonate(s), particularly preferably sodium carbonate, in quantities of 2 to 50 wt. %, preferably 5 to 40 wt. % and in particular 7.5 to 30 wt. %, based on total weight of the washing or cleaning agent. Particularly preferred agents contain, based on total weight of the washing or cleaning agent, 20 wt. % or less, preferably 17 wt. % or less, preferably 13 wt. % or less, and in particular 9 wt. % or less of carbonate(s) and/or hydrogencarbonate(s), preferably alkali metal carbonate(s), particularly preferably sodium carbonate.

Organic cobuilders which may in particular be mentioned are polycarboxylates/polycarboxylic acids, polymeric polycarboxylates, aspartic acid, polyacetals, dextrins, further organic cobuilders and phosphonates. These classes of substances are described below.

Usable organic builder materials include polycarboxylic acids usable in the form of the free acid and/or the sodium salts thereof, polycarboxylic acids meaning those carboxylic acids having more than one acid function. These include citric acid, adipic acid, succinic acid, glutaric acid, malic acid, tartaric acid, maleic acid, fumaric acid, saccharic acids, aminocarboxylic acids, nitrilotriacetic acid (NTA), provided that there are no environmental restrictions, together with mixtures thereof. Apart from their builder action, free acids typically also have the property of an acidifying component and so also serve to establish a lower and gentler pH value for washing or cleaning agents. Citric acid, succinic acid, glutaric acid, adipic acid, gluconic acid and any desired mixtures of these may in particular be mentioned.

Further suitable builders include polymeric polycarboxylates such as the alkali metal salts of polyacrylic acid or polymethacrylic acid, for example, those with a relative molecular mass of 500 to 70,000 g/mol.

Molar masses indicated for polymeric polycarboxylates comprise for the purposes of this document weight-average molar masses M_{w} of the respective acid form, these having in principle been determined by means of gel permeation chromatography (GPC) using a UV detector. Measurement was here made relative to an external polyacrylic acid standard, which supplies realistic molecular weight values as a result of its structural relatedness to the polymers under investigation. These values differ markedly from the molecular weight values in which polystyrenesulfonic acids are used as the standard. The molar masses measured relative to polystyrenesulfonic acids are generally markedly higher than the molar masses indicated in the present document.

Suitable polymers are in particular polyacrylates, which preferably have a molecular mass of 2000 to 20,000 g/mol. Due to their superior solubility, short-chain polyacrylates from this group are preferred, these having molar masses from 2000 to 10,000 g/mol, particularly preferably from 3000 to 5000 g/mol.

Also suitable are copolymeric polycarboxylates, particularly those of acrylic acid with methacrylic acid and acrylic acid or methacrylic acid with maleic acid. Copolymers of acrylic acid with maleic acid containing 50 to 90 wt. % acrylic acid and 50 to 10 wt. % maleic acid have proven particularly suitable. Their relative molecular mass, relative to free acids, is generally 2000 to 70,000 g/mol, preferably 20,000 to 50,000 g/mol and in particular 30,000 to 40,000 g/mol.

The (co)polymeric polycarboxylates may be used either as a powder or as an aqueous solution. The content of (co)polymeric polycarboxylates in the washing or cleaning agents is preferably 0.5 to 20 wt. % and in particular to 3 to 10 wt. %.

In order to improve water solubility, the polymers may also contain allylsulfonic acids such as allyloxybenzenesulfonic acid and methallylsulfonic acid as a monomer.

In particular, biodegradable polymers prepared from more than two different monomer units are preferred, for example, those containing salts of acrylic acid and of maleic acid and vinyl alcohol or vinyl alcohol derivatives as monomers, or containing salts of acrylic acid and of 2-alkylallylsulfonic acid and sugar derivatives as monomers.

Further preferred copolymers contain acrolein and acrylic acid/acrylic acid salt or acrolein and vinyl acetate as monomers.

Polymers with a water-softening action include polymers containing sulfonic acid groups which are particularly preferentially used. Corresponding polymers have previously been described above as components of bleach activator granules according to the invention, for which reference is made to the explanations provided therein in order to avoid repetition.

Polymeric aminodicarboxylic acids, the salts thereof or the precursor substances thereof may likewise be mentioned as further preferred builder substances. Polyaspartic acid or the salts thereof are particularly preferred.

Further suitable builder substances are polyacetals which may be obtained by reacting dialdehydes with polyolcarboxylic acids which comprise 5 to 7 C atoms and at least 3 hydroxyl groups. Preferred polyacetals are obtained from dialdehydes such as glyoxal, glutaraldehyde, terephthalaldehyde as well as mixtures thereof and from polyolcarboxylic acids such as gluconic acid and/or glucoheptonic acid.

Oxydisuccinates and other derivatives of disuccinates, preferably ethylenediamine disuccinate, are also further suitable cobuilders. Ethylenediamine-N,N′-disuccinate (EDDS) is here preferably used in the form of the sodium or magnesium salts thereof. Glycerol disuccinates and glycerol trisuccinates are also additionally preferred in this connection. Suitable amounts used are 3 to 15 wt. %.

In addition to 1-hydroxyethane-1,1-diphosphonic acid, the complexing phosphonates comprise a series of different compounds such as diethylenetriaminepenta(methylenephosphonic acid) (DTPMP). Hydroxyalkane- or aminoalkanephosphonates in particular are preferred in the present application. Among hydroxyalkanephosphonates, 1-hydroxyethane-1,1-diphosphonate (HEDP) is of particular significance as a cobuilder. It is preferably used as a sodium salt, the disodium salt exhibiting a neutral reaction and the tetrasodium salt an alkaline (pH 9) reaction. Aminoalkanephosphonates which may preferably be considered include ethylenediaminetetramethylenephosphonate (EDTMP), diethylenetriaminepentamethylene-phosphonate (DTPMP) as well as the higher homologs thereof. They are preferably used in the form of the sodium salts which exhibit a neutral reaction, for example as the hexasodium salt of EDTMP or as the hepta- and octasodium salt of DTPMP. From the class of phosphonates, HEDP is here preferably used as a builder. Aminoalkanephosphonates furthermore exhibit a pronounced heavy metal binding capacity. It may accordingly be preferred, especially if the agents also contain bleach, to use aminoalkanephosphonates, in particular DTPMP, or mixtures of the stated phosphonates.

A preferred automatic dishwashing agent for the purposes of the present application contains one or more phosphonate(s) from the group—
a) aminotrimethylenephosphonic acid (ATMP) and/or the salts thereof;
b) ethylenediaminetetra(methylenephosphonic acid) (EDTMP) and/or the salts thereof;
c) diethylenetriaminepenta(methylenephosphonic acid) (DTPMP) and/or the salts thereof;
d) 1-hydroxyethane-1,1-diphosphonic acid (HEDP) and/or the salts thereof;
e) 2-phosphonobutane-1,2,4-tricarboxylic acid (PBTC) and/or the salts thereof;

f) hexamethylenediaminetetra(methylenephosphonic acid) (HDTMP) and/or the salts thereof;

g) nitrilotri(methylenephosphonic acid) (NTMP) and/or the salts thereof.

Particularly preferred automatic dishwashing agents include those containing 1-hydroxyethane-1,1-diphosphonic acid (HEDP) or diethylenetriamine-penta(methylenephosphonic acid) (DTPMP) as phosphonates.

Automatic dishwashing agents according to the invention can contain two or more different phosphonates.

Bi- or multiphase washing or cleaning agents containing at least one phosphonate, preferably 1-hydroxyethane-1,1-diphosphonic acid (HEDP), which is present together with bleaching agent a) in one phase of the washing or cleaning agent, are preferred according to the invention.

The amount of phosphonates in the agent is preferably from 0.5 to 14 wt. %, more preferably 1 to 12 wt. %, and particularly 2 to 8 wt. %.

Some example formulations of preferred bi- or multiphase washing or cleaning agents containing phosphonate are illustrated in the following tables—

| | Formulation | Formulation 22 | Formulation 23 | Formulation 24 |
|---|---|---|---|---|
| Ingredient [phase] | 21 [wt. %] | [wt. %] | [wt. %] | [wt. %] |
| Oxygen bleaching agent [1] | 2 to 30 | 4 to 20 | 4 to 20 | 6 to 15 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |
| Phosphonate* | 0.5 to 14 | 1 to 12 | 1 to 12 | 2 to 8 |

*As a component of phase [1] and/or one or more further phases.

Automatic dishwashing agents according to the invention particularly preferentially contain methylglycinediacetic acid or a salt of methylglycinediacetic acid, wherein the amount of methylglycinediacetic acid or salt of methylglycinediacetic acid is preferably from 0.5 to 15 wt. %, preferably from 0.5 to 10 wt. % and particularly from 0.5 to 6 wt. %, based on total weight of the agent.

Further usable organic cobuilders include acetylated hydroxycarboxylic acids or the salts thereof, which may optionally also be present in lactone form and contain at least 4 carbon atoms and at least one hydroxyl group and at most two acid groups.

Any compounds capable of forming complexes with alkaline earth ions can also be used as builders.

Surfactants include nonionic, anionic, cationic and amphoteric surfactants.

Any nonionic surfactant known to one skilled in the art can be used as the nonionic surfactant. Suitable nonionic surfactants include alkyl glycosides according to the general formula RO(G)ₓ, wherein R is a primary straight-chain or methyl-branched aliphatic residue, in particular methyl-branched in position 2, with 8 to 22, preferably 12 to 18 C atoms and G is a glycose unit with 5 or 6 C atoms, preferably glucose. The degree of oligomerization x, which indicates the distribution of monoglycosides and oligoglycosides, is any desired number from 1 to 10; x is preferably 1.2 to 1.4.

A further class of preferably used nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain.

Low-foaming nonionic surfactants can be used as preferred surfactants. Washing or cleaning agents, in particular cleaning agents for automatic dishwashing, particularly preferentially contain nonionic surfactants from the group of alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. Preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EU or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EU. The stated degrees of ethoxylation are statistical averages which, for a specific product, may be an integer or a fractional number. Preferred alcohol ethoxylates have a narrow homolog distribution (narrow range ethoxylates, NRE). In addition to these nonionic surfactants, fatty alcohols with more than 12 EO may also be used. Examples of these are tallow fatty alcohol with 14 EU, 25 EU, 30 EO or 40 EU.

Ethoxylated nonionic surfactants obtained from C₆₋₂₀ monohydroxyalkanols or C₆₋₂₀ alkylphenols or C₁₆₋₂₀ fatty alcohols and more than 12 mol, preferably more than 15 mol and in particular more than 20 mol of ethylene oxide per mol of alcohol are accordingly particularly preferentially used. One particularly preferred nonionic surfactant is obtained from a straight-chain fatty alcohol having 16 to 20 carbon atoms (C₁₆₋₂₀ alcohol), preferably a C₁₋₈ alcohol, and at least 12 mol, preferably at least 15 mol and in particular at least 20 mol of ethylene oxide. Among these, “narrow range ethoxylates” are particularly preferred.

Combinations of one or more tallow fatty alcohols with 20 to 30 EO and silicone defoamers are particularly preferentially used.

In particular, nonionic surfactants having a melting point of above room temperature are preferred. Nonionic surfactant(s) with a melting point of 20° C. or greater, preferably 25° C. or greater, particularly preferably from 25 to 60° C. and in particular from 26.6 to 43.3° C., is/are particularly preferred.

Preferred surfactants originate from alkoxylated nonionic surfactants, in particular ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are furthermore distinguished by good foam control.

Further nonionic surfactants with a melting point above room temperature which are particularly preferably used contain 40 to 70% of a polyoxypropylene/polyoxyethylene/polyoxypropylene block polymer blend, which contains 75 wt. % of a reverse block copolymer of polyoxyethylene and polyoxypropylene with 17 mol of ethylene oxide and 44 mol of propylene oxide and 25 wt. % of a block copolymer of polyoxyethylene and polyoxypropylene, initiated with trimethylolpropane and containing 24 mol of ethylene oxide and 99 mol of propylene oxide per mol of trimethylolpropane.

Nonionic surfactants particularly preferred for the purposes of the present invention include low-foaming nonionic surfactants having alternating ethylene oxide and alkylene oxide units. Among these, surfactants with EO-AO-EO-AO blocks are in turn preferred, each having one to ten EO or AO groups attached to one another before being followed by a block of the respective other groups. Preferred nonionic surfactants are those of the general formula—

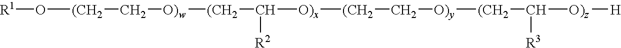

wherein R¹ is a straight-chain or branched, saturated or mono- or polyunsaturated C₆₋₂₄ alkyl or alkenyl residue; R² and R³ are mutually and independently —CH₃, —CH₂CH₃, —CH₂CH₂—CH₃, or CH(CH₃)₂, and indices w, x, y, z are mutually and independently integers from 1 to 6.

Nonionic surfactants are preferably in particular those having a C₉₋₁₅ alkyl residue with 1 to 4 ethylene oxide units, followed by 1 to 4 propylene oxide units, followed by 1 to 4 ethylene oxide units, followed by 1 to 4 propylene oxide units. In aqueous solution, these surfactants exhibit the necessary low viscosity and may particularly preferentially be used according to the invention.

Surfactants of the general formula R¹—CH(OH)CH₂O-(AO)_{w}-(A′O)ₓ-(A″O)_{y}-(A′″O)_{z}—R², wherein R¹ and R² are mutually and independently a straight-chain or branched, saturated or mono- or polyunsaturated C₂₋₄₀ alkyl or alkenyl residue; A, A′, A″ and A′″ are mutually and independently a residue chosen from —CH₂CH₂, —CH₂CH₂—CH₂, —CH₂—CH(CH₃), —CH₂—CH₂—CH₂—CH₂, —CH₂—CH(CH₃)—CH₂—, or —CH₂—CH(CH₂—CH₃); and w, x, y and z are values from 0.5 to 90, with x, y and/or z possibly also being 0, are preferred according to the invention.

In particular, preferred end group-terminated poly(oxyalkylated) nonionic surfactants are those which, according to the formula R¹O[CH₂CH₂O]ₓCH₂CH(OH)R², in addition to a residue R¹, which denotes linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, x denoting values between 1 and 90, preferably values between 30 and 80 and in particular values between 30 and 60.

Particularly preferred surfactants are those of the formula R¹O[CH₂CH(CH₃)O]ₓ[CH₂CH₂O]_{y}CH₂CH(OH)R², wherein R¹ is a linear or branched aliphatic hydrocarbon residue with 4 to 18 carbon atoms or mixtures thereof, R² is a linear or branched hydrocarbon residue with 2 to 26 carbon atoms or mixtures thereof, x is a value from 0.5 to 1.5, and y is a value of at least 15.

Particularly preferred end group-terminated poly(oxyalkylated) nonionic surfactants are furthermore those of the formula R¹O[CH₂CH₂O]ₓ[CH₂CH(R³)O]_{y}CH₂CH(OH)R², wherein R¹ and R² are mutually and independently a linear or branched, saturated or mono- or polyunsaturated hydrocarbon residue with 2 to 26 carbon atoms, R³ independently is —CH₃, —CH₂CH₃, —CH₂CH₂—CH₃, —CH(CH₃)₂, preferably —CH₃, and x and y are mutually and independently values from 1 to 32, with nonionic surfactants wherein R³=—CH₃, x is from 15 to 32, and y is from 0.5 and 1.5 being very particularly preferred.

Further preferably usable nonionic surfactants include end group-terminated poly(oxyalkylated) nonionic surfactants according to the formula R¹O[CH₂CH(R³)O]ₓ[CH₂]ₖCH(OH)[CH₂]ⱼOR², wherein R¹ and R² are linear or branched, saturated or unsaturated, aliphatic or aromatic hydrocarbon residues with 1 to 30 carbon atoms, R³ is H or a methyl, ethyl, n-propyl, iso-propyl, n-butyl, 2-butyl or 2-methyl-2-butyl residue, x is a value from 1 to 30, and k and j are values from 1 to 12, preferably from 1 to 5. If the value of x is ≧2, each R³ in the above formula may be R¹O[CH₂CH(R³)O]ₓ[CH₂]ₖCH(OH)[CH₂]ⱼOR² different. R¹ and R² are preferably linear or branched, saturated or unsaturated, aliphatic or aromatic hydrocarbon residues with 6 to 22 carbon atoms, residues with 8 to 18 C atoms being particularly preferred. H, —CH₃ or —CH₂CH₃ are particularly preferred for the residue R³. Particularly preferred values for x are in the range from 1 to 20, in particular from 6 to 15.

As described above, each R³ in the above formula may be different if x is ≧2. In this manner, it is possible to vary the alkylene oxide unit in the square brackets. If denotes 3, for example, the residue R³ may be selected in order to form ethylene oxide (R³═H) or propylene oxide (R³═CH₃) units which may be attached to one another in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and may perfectly well be larger, the range of variation increasing as the value of x rises and for example comprising a large number of (EO) groups combined with a small number of (PO) groups, or vice versa.

Particularly preferred end group-terminated poly(oxyalkylated) alcohols of the above-stated formula have values of k=1 and j=1, so simplifying the above formula to R¹O[CH₂CH(R³)O]ₓCH₂CH(OH)CH₂OR². In the latter-stated formula, R¹, R² and R³ are as defined above and x denotes numbers from 1 to 30, preferably from 1 to 20 and in particular from 6 to 18. Particularly preferred surfactants are those wherein R¹ and R² comprise 9 to 14 C atoms, R³ is H and x is a value from 6 to 15.

The stated C chain lengths and degrees of ethoxylation or degrees of alkoxylation of the above-stated nonionic surfactants are statistical averages which, for a specific product, may be an integer or a fractional number. Due to production methods, commercial products of the stated formulae do not in the main consist of an individual representative, but instead of mixtures, whereby not only the C-chain lengths but also the degrees of ethoxylation or degrees of alkoxylation may be averages and consequently fractional numbers.

The above-stated nonionic surfactants may, of course, be used not only as individual substances, but also as surfactant mixtures of two, three, four or more surfactants. Surfactant mixtures do not here comprise mixtures of nonionic surfactants all of which fall within one of the above-stated general formulae, but instead such mixtures which contain two, three, four or more nonionic surfactants which may be described by various of the above-stated general formulae.

If anionic surfactants are used as a component of automatic dishwashing agents, the content thereof, relative to the total weight of the agents, preferably amounts to less than 4 wt. %, preferably to less than 2 wt. % and very particularly preferably to less than 1 wt. %. Automatic dishwashing agents containing no anionic surfactants are particularly preferred.

Cationic and/or amphoteric surfactants may be used instead of or in conjunction with the stated surfactants.

In automatic dishwashing agents, the content of cationic and/or amphoteric surfactants preferably amounts to less than 6 wt. %, preferably less than 4 wt. %, very particularly preferably less than 2 wt. % and in particular less than 1 wt. %. Automatic dishwashing agents containing no cationic or amphoteric surfactants are particularly preferred.

Some example formulations for preferred bi- or multiphase washing or cleaning agents containing surfactants are illustrated in the following tables—

| | Formulation | Formulation 26 | Formulation 27 | Formulation 28 |
|---|---|---|---|---|
| Ingredient [phase] | 25 [wt. %] | [wt. %] | [wt. %] | [wt. %] |
| Oxygen bleaching agent [1] | 2 to 30 | 4 to 20 | 4 to 20 | 6 to 15 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |
| Nonionic surfactant* | 0.1 to 15 | 0.2 to 10 | 0.5 to 8 | 1 to 6 |

*As a component of phase [1] and/or one or more further phases.

Polymers in particular include polymers with a washing or cleaning action, for example, rinsing polymers and/or polymers with a water-softening action. In general, in addition to nonionic polymers, it is also possible to use cationic, anionic and amphoteric polymers in washing or cleaning agents.

“Cationic polymers” for the purposes of the present invention are polymers which bear a positive charge in the polymer molecule. This may for example be achieved by (alkyl)ammonium groupings or other positively charged groups present in the polymer chain. Particularly preferred cationic polymers originate from quaternized cellulose derivatives, polysiloxanes with quaternary groups, cationic guar derivatives, polymeric dimethyldiallylammonium salts and the copolymers thereof with esters and amides of acrylic acid and methacrylic acid, copolymers of vinylpyrrolidone with quaternized derivatives of dialkylamino acrylate and methacrylate, vinylpyrrolidone/methoimidazolinium chloride copolymers, quaternized polyvinyl alcohols or the polymers known by the INCI names Polyquaternium 2, Polyquaternium 17, Polyquaternium 18 and Polyquaternium 27.

In addition to a positively charged group in the polymer chain, “amphoteric polymers” for the purposes of the present invention also comprise negatively charged groups or monomer units. These include carboxylic acids, sulfonic acids or phosphonic acids.

Preferred washing or cleaning agents, in particular preferred automatic dishwashing agents, contain a polymer a) comprising monomer units of the formula R¹R²C═CR³R⁴, wherein R¹, R², R³, and R⁴ are mutually and independently selected from hydrogen, derivatized hydroxy group, C₁₋₃₀ linear or branched alkyl groups, aryl, C₁₋₃₀ linear or branched alkyl groups substituted with aryl, polyalkoxylated alkyl groups, heteroatomic organic groups with at least one positive charge without charged nitrogen, at least one quaternized N atom or at least one amino group with a positive charge in the subrange of the pH range of 2 to 11, or salts thereof, with the proviso that at least one residue R¹, R², R³, R⁴ is a heteroatomic organic group with at least one positive charge without charged nitrogen, at least one quaternized N atom or at least one amino group with a positive charge.

Cationic or amphoteric polymers which are particularly preferred for the purposes of the present application contain as monomer unit a compound of the general formula—

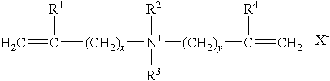

wherein R¹ and R⁴ are mutually and independently H or a linear or branched hydrocarbon residue with 1 to 6 carbon atoms; R² and R³ are mutually and independently an alkyl, hydroxyalkyl or aminoalkyl group in which the alkyl residue is linear or branched and has from 1 to 6 carbon atoms, preferably comprising a methyl group; x and y are mutually and independently integers from 1 to 3. X⁻ is a counterion, preferably chloride, bromide, iodide, sulfate, hydrogensulfate, methosulfate, lauryl sulfate, dodecylbenzenesulfonate, p-toluenesulfonate (tosylate), cumenesulfonate, xylenesulfonate, phosphate, citrate, formate, acetate or mixtures thereof.

Preferably, R¹ and R⁴ in the above formula are chosen from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃ and —(CH₂CH₂—O)ₙH.

Very particularly preferred polymers are those having a cationic monomer unit of the above general formula, wherein R¹ and R⁴ are H, R² and R³ are methyl, and x and y are each 1. The corresponding monomer unit of the formula—

H₂C═CH—(CH₂)—N⁺(CH₃)₂—(CH₂)—CH═CH₂X⁻

is also known as DADMAC (diallyldimethylammonium chloride) when X⁻ is chloride.

Further particularly preferred cationic or amphoteric polymers contain a monomer unit of the general formula—

R¹HC═CR²—C(O)—NH—(CH₂)ₓN⁺R³R⁴R⁵X⁻

wherein R¹, R², R³, R⁴ and R⁵ are mutually and independently a linear or branched, saturated or unsaturated alkyl or hydroxyalkyl residue with 1 to 6 carbon atoms, preferably a linear or branched alkyl residue chosen from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃ and —(CH₂CH₂—O)ₙH and x is an integer from 1 to 6.

Polymers which are very particularly preferred for the purposes of the present application are those which comprise a cationic monomer unit of the above general formula, in which R¹ denotes H and R², R³, R⁴ and R⁵ denote methyl and x denotes 3. The corresponding monomer units of the formula—

H₂C═C(CH₃)—C(O)—NH—(CH₂)—OCH₃)₃X⁻

are also known as MAPTAC (methyacrylamidopropyltrimethylammonium chloride) when X⁻ is chloride.

Polymers containing diallyldimethylammonium salts and/or acrylamidopropyltrimethylammonium salts as monomer units are preferably used according to the invention.

The previously mentioned amphoteric polymers comprise not only cationic groups, but also anionic groups or monomer units. Such anionic monomer units can originate from linear or branched, saturated or unsaturated carboxylates, linear or branched, saturated or unsaturated phosphonates, linear or branched, saturated or unsaturated sulfates or linear or branched, saturated or unsaturated sulfonates. Preferred monomer units include acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid and the derivatives thereof, allylsulfonic acids such as allyloxybenzenesulfonic acid and methallylsulfonic acid or allylphosphonic acids.

Preferably usable amphoteric polymers originate from alkylacrylamide/acrylic acid copolymers, alkylacrylamide/methacrylic acid copolymers, alkylacrylamide/methyl methacrylic acid copolymers, alkylacrylamide/acrylic acid/alkylaminoalkyl (meth)acrylic acid copolymers, alkylacrylamide/methacrylic acid/alkylaminoalkyl (meth)acrylic acid copolymers, alkylacrylamide/methyl methacrylic acid/alkylaminoalkyl (meth)acrylic acid copolymers, alkylacrylamide/alkyl methacrylate/alkylaminoethyl methacrylate/alkyl methacrylate copolymers and copolymers of unsaturated carboxylic acids, cationically derivatized unsaturated carboxylic acids and optionally further ionic or nonionogenic monomers.

Preferably usable zwitterionic polymers originate from acrylamidoalkyltrialkylammonium chloride/acrylic acid copolymers and the alkali metal and ammonium salts thereof, acrylamidoalkyltrialkylammonium chloride/methacrylic acid copolymers and the alkali metal and ammonium salts thereof and methacroylethylbetaine/methacrylate copolymers.

Amphoteric polymers which, in addition to one or more anionic monomers, comprise methacrylamidoalkyltrialkylammonium chloride and dimethyl(diallyl)ammonium chloride as cationic monomers are furthermore preferred.

Particularly preferred amphoteric polymers originate from methacrylamidoalkyltrialkylammonium chloride/dimethyl(diallyl)ammonium chloride/acrylic acid copolymers, methacrylamidoalkyltrialkylammonium chloride/dimethyl(diallyl)ammonium chloride/methacrylic acid copolymers and methacrylamidoalkyltrialkylammonium chloride/dimethyl(diallyl)ammonium chloride/alkyl(meth)acrylic acid copolymers and the alkali metal and ammonium salts thereof.

Particularly preferred amphoteric polymers include methacrylamidopropyltrimethylammonium chloride/dimethyl(diallyl)ammonium chloride/acrylic acid copolymers, methacrylamidopropyltrimethylammonium chloride/dimethyl(diallyl)ammonium chloride/acrylic acid-copolymers and methacrylamidopropyltrimethylammonium chloride/dimethyl(diallyl)ammonium chloride/alkyl(meth)acrylic acid copolymers and the alkali metal and ammonium salts thereof.

Washing or cleaning agents preferably contain the above-stated cationic and/or amphoteric polymers in quantities of from 0.01 to 10 wt. %, based on total weight of the washing or cleaning agent. Washing or cleaning agents which are preferred for the purposes of the present application are, however, those in which the proportion by weight of cationic and/or amphoteric polymers is from 0.01 to 8 wt. %, preferably from 0.01 to 6 wt. %, preferably from 0.01 to 4 wt. %, particularly preferably from 0.01 to 2 wt. % and in particular from 0.01 to 1 wt. %, based on total weight of the automatic dishwashing agent.

Enzymes can be used to increase the washing or cleaning performance of washing or cleaning agents. These include in particular proteases, amylases, lipases, hemicellulases, cellulases, perhydrolases or oxidoreductases, and preferably mixtures thereof. These enzymes are in principle of natural origin; starting from the natural molecules, improved variants are available for use in washing or cleaning agents, said variants accordingly preferably being used. Washing or cleaning agents preferably contain enzymes in total quantities of 1×10⁻⁶ to 5 wt. % relative to active protein. Protein concentration may be determined with the assistance of known methods, for example the BCA method or the biuret method.

Among proteases, those of the subtilisin type are preferred. Examples of these are subtilisins BPN' and Carlsberg and their further developed forms protease PB92, subtilisins 147 and 309, alkaline protease from Bacillus lentus, subtilisin DY and the enzymes thermitase, proteinase K and proteases TW3 and TW7, which are classed among subtilases but no longer among the subtilisins as more narrowly defined.

Examples of amylases usable according to the invention are the α-amylases from Bacillus licheniformis, from B. amyloliquefaciens, from B. stearothermophilus, from Aspergillus niger and A. oryzae and the further developed forms of the above-stated amylases which have been improved for use in washing or cleaning agents. Particular note should furthermore be taken for this purpose of the α-amylase from Bacillus sp. A 7-7 (DSM 12368) and the cyclodextrin glucanotransferase (CGTase) from B. agaradherens (DSM 9948).

One or more enzymes and/or enzyme preparations, preferably solid protease preparations and/or amylase preparations, are preferably used in quantities of 0.1 to 5 wt. %, preferably of 0.2 to 4.5 wt. % and in particular of 0.4 to 4 wt. %, in each case relative to the entire enzyme-containing agent.

Some example formulations for preferred bi- or multiphase washing or cleaning agents containing enzymes are illustrated in the following tables—

| | Formulation | Formulation 30 | Formulation 31 | Formulation 32 |
|---|---|---|---|---|
| Ingredient [phase] | 29 [wt. %] | [wt. %] | [wt. %] | [wt. %] |
| Oxygen bleaching agent [1] | 2 to 30 | 4 to 20 | 4 to 20 | 6 to 15 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |
| Enzyme preparation [≠1] | 0.1 to 12 | 0.2 to 10 | 0.5 to 8 | 0.5 to 8 |

*As a component of phase [1] and/or one or more further phases.

Glass corrosion inhibitors prevent the occurrence not only of hazing, streaking and scratching but also of iridescence on the surface of machine washed glasses. Preferred glass corrosion inhibitors originate from the group of magnesium and zinc salts and of magnesium and zinc complexes.

The spectrum of preferred zinc salts according to the invention, preferably of organic acids, particularly preferably of organic carboxylic acids, extends from salts which are sparingly soluble or insoluble in water (i.e., exhibit a solubility of less than 100 mg/l, preferably less than 10 mg/l, in particular less than 0.01 mg/l) up to those salts which exhibit a solubility in water of 100 mg/l or greater, preferably greater than 500 mg/l, particularly preferably greater than 1 g/l and in particular greater than 5 g/l (all solubilities at 20° C. water temperature). The first group of zinc salts includes zinc citrate, zinc oleate and zinc stearate, while the soluble zinc salts include zinc formate, zinc acetate, zinc lactate and zinc gluconate.

At least one zinc salt of an organic carboxylic acid, particularly preferably a zinc salt from zinc stearate, zinc oleate, zinc gluconate, zinc acetate, zinc lactate and zinc citrate is particularly preferentially used as a glass corrosion inhibitor. Zinc ricinoleate, zinc abietate and zinc oxalate are also preferred.

For the purposes of the present invention, the amount of zinc salt in washing or cleaning agents is preferably from 0.1 to 5 wt. %, preferably from 0.2 to 4 wt. % and in particular from 0.4 to 3 wt. %, or the content of zinc in oxidized form (calculated as Zn²⁺) is from 0.01 to 1 wt. %, preferably from 0.02 to 0.5 wt. % and in particular from 0.04 to 0.2 wt. %, based on total weight of the agent containing the glass corrosion inhibitor.

Corrosion inhibitors protect the machine or items being washed, silver protection agents being of particular significance in relation to automatic dishwashing. Known prior art substances may be used. In general, useful silver protection agents include triazoles, benzotriazoles, bisbenzotriazoles, aminotriazoles, alkylaminotriazoles and transition metal salts or complexes. Benzotriazole and/or alkylaminotriazole are particularly preferably used.

Cleaning product formulations furthermore frequently comprise agents containing active chlorine which are capable of distinctly reducing corrosion of silver surfaces. Organic redox-active compounds containing oxygen and nitrogen, such as di- and trihydric phenols, for example hydroquinone, pyrocatechol, hydroxyhydroquinone, gallic acid, phloroglucinol, pyrogallol or derivatives of these classes of compounds are in particular used in chlorine-free cleaning products. Saline and complexed inorganic compounds, such as salts of metals Mn, Ti, Zr, Hf, V, Co and Ce are also frequently used. Preferred compounds are here transition metal salts, which are selected from the group of manganese and/or cobalt salts and/or complexes, particularly preferably the cobalt (amine) complexes, cobalt (acetate) complexes, cobalt (carbonyl) complexes, the chlorides of cobalt or manganese and of manganese sulfate. Zinc compounds may likewise by used to prevent corrosion of the articles being washed.

The stated metal salts and/or metal complexes are present in the cleaning agents according to the invention preferably in a quantity of from 0.05 to 6 wt. %, preferably 0.2 to 2.5 wt. %, based on total agent.

Bi- or multiphase washing or cleaning agents which are characterized in that the bi- or multiphase washing or cleaning agent furthermore contains a silver protection agent, which is present together with the bleaching agent a) in one phase of the washing or cleaning agent, are preferred according to the invention.

Some example formulations of preferred bi- or multiphase washing or cleaning agents containing silver protection agents are illustrated in the following tables—

| | Formulation | Formulation 34 | Formulation 35 | Formulation 36 |
|---|---|---|---|---|
| Ingredient [phase] | 33 [wt. %] | [wt. %] | [wt. %] | [wt. %] |
| Oxygen bleaching agent [1] | 2 to 30 | 4 to 20 | 4 to 20 | 6 to 15 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |
| Silver protection agent [1] | 0.05 to 6 | 0.05 to 6 | 0.2 to 2.5 | 0.2 to 2.5 |

| | Formulation | Formulation 38 | Formulation 39 | Formulation 40 |
|---|---|---|---|---|
| Ingredient [phase] | 37 [wt. %] | [wt. %] | [wt. %] | [wt. %] |
| Oxygen bleaching agent [1] | 2 to 30 | 4 to 20 | 4 to 20 | 6 to 15 |
| Bleach activator^{b} [1] | 0.1 to 10 | 0.5 to 8 | 0.5 to 8 | 1 to 6 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |
| Silver protection agent [1] | 0.05 to 6 | 0.05 to 6 | 0.2 to 2.5 | 0.2 to 2.5 |

^{b}Bleach activator in particulate form which, relative to the total weight thereof, comprises a bleach activator content of below 80 wt. %.

Perfume oils or fragrances which may be used for the purposes of the present invention include individual odoriferous compounds, for example, synthetic products of the ester, ether, aldehyde, ketone, alcohol and hydrocarbon type. Preferably, however, mixtures of various odoriferous substances are used which together produce an attractive fragrance note. Such perfume oils may also contain natural odoriferous mixtures, as are obtainable from plant sources, for example pine, citrus, jasmine, patchouli, rose or ylang-ylang oil.

Preferred dyes, the selection of which will cause the person skilled in the art no difficulty, have elevated storage stability and are insensitive to the other ingredients of the agents and to light and have no marked substantivity relative to the substrates such as for example textiles, glass, ceramics or plastic crockery to be treated with the dye-containing agents, so as not to dye these substrates.

Disintegration of prefabricated moldings may be facilitated by incorporating disintegration auxiliaries or “tablet disintegrants” into these agents in order to shorten disintegration times. Tablet disintegrants or disintegration accelerators are taken to mean auxiliary substances which ensure the rapid disintegration of tablets in water or other media and the prompt release of the active ingredients.

These substances, known as disintegrants due to their mode of action, increase in volume on exposure to water, resulting, on the one hand, in an increase of their own volume (swelling) and, on the other hand, possibly also in generation of pressure due to the release of gases, causing the tablet to break up into smaller particles. Disintegration auxiliaries which have long been known are for example carbonate/citric acid systems, it also being possible to use other organic acids. Swelling disintegration auxiliaries are for example synthetic polymers such as polyvinyl pyrrolidone (PVP) or natural polymers or modified natural materials such as cellulose and starch and the derivatives thereof, alginates or casein derivatives.

Disintegration auxiliaries are preferably used in quantities of 0.5 to 10 wt. %, preferably 3 to 7 wt. % and in particular 4 to 6 wt. %, based on total weight of the agent containing the disintegration auxiliary.

Preferred disintegration auxiliaries, preferably a cellulose-based disintegration auxiliary, preferably in granular, co-granulated or compacted form, are present in the agent containing the disintegration agent in quantities of 0.5 to 10 wt. %, preferably 3 to 7 wt. % and in particular 4 to 6 wt. %, based on total weight of the agent containing the disintegration agent.

Gas-evolving effervescent systems may furthermore preferably be used according to the invention as tablet disintegration auxiliaries. The gas-evolving effervescent system may consist of a single substance which releases a gas on contact with water. Magnesium peroxide, which releases oxygen on contact with water, may in particular be mentioned among these compounds. Conventionally, however, the gas-releasing effervescent system in turn consists of at least two components which react with one another to form gas. While numerous systems which for example release nitrogen, oxygen or hydrogen may be imagined and implemented, the effervescent system used in the washing and cleaning agents will be selected in the light of both economic and environmental considerations. Preferred effervescent systems consist of alkali metal carbonate and/or hydrogen carbonate and an acidifying agent suitable for releasing carbon dioxide from the alkali metal salts in aqueous solution.

Usable acidifying agents which release carbon dioxide from the alkali metal salts in aqueous solution include boric acid and alkali metal hydrogen sulfates, alkali metal dihydrogen phosphates and other inorganic salts. Organic acidifying agents are, however, preferably used, citric acid being a particularly preferred acidifying agent. Preferred acidifying agents in the effervescent system are from the group of organic di-, tri- and oligocarboxylic acids or mixtures.

Washing or cleaning agents according to the invention are present as bi- or multiphase presentations, preferably in the form of bi-, tri- or tetraphase presentations.

These presentations are themselves preferably formulated in the form of a dispensing unit. In the present application, the phrase “washing or cleaning agent dispensing unit” refers to those presentations having a sufficient quantity of substances with a washing and cleaning action to carry out individual cleaning cycles. Such presentations preferably have, for example, a weight of from 8 to 35 g, preferably from 10 to 30 g and in particular from 12 to 25 g. The volume of the moldings is conventionally in the range from 5 to 40 ml, preferably from 8 to 30 ml, and in particular from 12 to 20 ml.

Particularly preferred washing or cleaning agent dispensing units have dimensions in the order of 5 cm×3 cm×3 cm, preferably in the order of 4.5 cm×2.5 cm×2.5 cm, particularly preferably in the order of 4 cm×2 cm×2 cm.

In the context of the present application, a “phase” of these bi- or multiphase washing or cleaning agent dispensing units means macroscopically visible regions of these dispensing units. For tableted washing or cleaning agent dispensing units, these can comprise layers or cores. In the case of dispensing units in the form of injection moldings or film pouches, the preparations with a washing or cleaning action which are present separately from one another in the compartments of these dispensing units are described as “phases”.

Bi- or multiphase washing or cleaning agents according to the invention may comprise solid or liquid phases or combinations of solid and liquid phases.

Examples of the above-described bi- or multiphase washing or cleaning agent dispensing units include, as previously explained, bi- or multilayer tablets, injection moldings with two or more compartments separate from one another, or film pouches with two or more compartments separate from one another.

In a particularly preferred embodiment, bi- or multiphase washing or cleaning agents according to the invention are in the form of bi- or multiphase, preferably bi- or multilayer tablets.

Individual phases of the bi- or multiphase base tablet or core tablet are preferably arranged in layers. The proportion by weight of the smallest phase preferably amounts, relative to the entire tablet, to at least 5 wt. %, preferably at least 10 wt. % and in particular at least 20 wt. %. The proportion by weight of the phase with the greatest proportion by weight in the tablet preferably amounts in biphasic tablets to no more than 90 wt. %, preferably no more than 80 wt. % and in particular from 55 to 70 wt. %. In triphasic tablets, the proportion by weight of the phase with the greatest proportion by weight in the tablet preferably amounts to no more than 80 wt. %, preferably no more than 70 wt. % and in particular from 35 to 60 wt. %.

The dishwashing agent tablets are preferably produced in a manner known to a person skilled in the art by press-molding particulate premixes. It is here preferred according to the invention for the particulate premix to exhibit an average particle size of between 0.4 and 3.0 mm, preferably between 0.6 and 2.5 mm and in particular between 0.8 and 2.0 mm.

Methods which are preferred for the purposes of the present invention are characterized in that press-molding proceeds at molding pressures of 0.01 to 50 KNcm⁻², preferably 0.1 to 40 kNcm⁻² and in particular 1 to 25 kNcm⁻².

The density of dishwashing agent tablets preferred according to the invention is from 1.1 to 1.8 g/cm³, preferably from 1.2 to 1.7 g/cm³ and in particular from 1.3 to 1.6 g/cm³.

The present application accordingly also provides a method of producing a bi- or multiphase washing or cleaning agent tablet, wherein a particulate premix comprising—
a) a bleaching agent
b) a bleach activator
c) a bleach catalyst chosen from bleach-boosting transition metal salts and transition metal complexes,
   is produced and press-molded to form a tablet so that the bleaching agent a) is present, separately from components b) and c), in a separate phase of the washing or cleaning agent, characterized in that the bleach activator b) is used in particulate form and the bleach activator particles have, relative to the total weight thereof, a content of bleach activator of above 80 wt. %.

Some example formulations of preferred bi- or multiphase washing or cleaning agent tablets are illustrated in the following tables—

| | Formulation | Formulation | Formulation | Formulation |
|---|---|---|---|---|
| Ingredient [phase] | 41 [wt. %] | 42 [wt. %] | 43 [wt. %] | 44 [wt. %] |
| Oxygen bleaching agent [1] | 2 to 30 | 4 to 20 | 4 to 20 | 6 to 15 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |
| Builder* | 1 to 60 | 2 to 50 | 5 to 50 | 10 to 50 |
| Polymer containing acid groups* | 0.1 to 30 | 0.5 to 25 | 1 to 20 | 1 to 20 |
| Nonionic surfactant* | 0.1 to 15 | 0.2 to 10 | 0.5 to 8 | 1 to 6 |
| Enzyme preparation [≠1] | 0.1 to 12 | 0.2 to 10 | 0.5 to 8 | 0.5 to 8 |

*Component of phases [1] and/or [2] and/or one or more further phases.

| | Formulation | Formulation | Formulation | Formulation |
|---|---|---|---|---|
| Ingredient [phase] | 45 [wt. %] | 46 [wt. %] | 47 [wt. %] | 48 [wt. %] |
| Oxygen bleaching agent [1] | 2 to 30 | 4 to 20 | 4 to 20 | 6 to 15 |
| Bleach activator^{b} [1] | 0.1 to 10 | 0.5 to 8 | 0.5 to 8 | 1 to 6 |
| Bleach activator [≠1] | 0.1 to 10 | 0.5 to 8 | 0.5 to 8 | 1 to 6 |
| Bleach catalyst [≠1] | 0.001 to 3 | 0.001 to 3 | 0.01 to 2 | 0.01 to 1.0 |
| Builder* | 1 to 60 | 2 to 50 | 5 to 50 | 10 to 50 |
| Polymer containing acid groups* | 0.1 to 30 | 0.5 to 25 | 1 to 20 | 1 to 20 |
| Nonionic surfactant* | 0.1 to 15 | 0.2 to 10 | 0.5 to 8 | 1 to 6 |
| Enzyme preparation [≠1] | 0.1 to 12 | 0.2 to 10 | 0.5 to 8 | 0.5 to 8 |
| Silver protection agent [1] | 0.05 to 6 | 0.05 to 6 | 0.2 to 2.5 | 0.2 to 2.5 |

^{b}Bleach activator in particulate form which, relative to the total weight thereof, comprises a bleach activator content of below 80 wt. %.
*Component of phases [1] and/or [2] and/or one or more further phases.

In order to increase throughput, rotary presses may also be provided with two feed shoes, as a result of which it is then only necessary to execute a half rotation to produce a tablet.

As initially mentioned, for the purposes of the present invention, the tablets may likewise be of multiphase, in particular multilayer, structure. The moldings may here be manufactured in a predetermined three-dimensional shape and predetermined size. Three-dimensional shapes which may be considered include virtually any developments which can sensibly be handled, thus for example slabs, rods or bars, cubes, cuboids and corresponding three-dimensional elements with planar side faces and in particular cylindrical developments with a circular or oval cross-section. This final development here includes presentations ranging from a tablet up to compact cylindrical pieces with a ratio of height to diameter of above 1.

Bi- and multilayer moldings are produced by arranging two or more feed shoes in succession, without the gently pressed first layer being ejected before further filling. In this manner, it is possible by suitable process control also to produce jacketed and bull's eye tablets, which have an onion skin type structure, in which in the case of bull's eye tablets the upper side of the core or of the core layers is not covered and thus remains visible. Recessed tablets which comprise a recess (a cavity open on one side defined by webs and a base area) on their upper side may furthermore also be produced.

Particularly preferred bi- or multiphase washing or cleaning agents according to the invention have the form of a recessed tablet with a core inserted, preferably pressed, into the recess.

Corresponding methods for producing a dishwashing agent tablet are characterized in that a particulate premix comprising—
a) a bleaching agent
b) a bleach activator
c) a bleach catalyst selected from the group of bleach-boosting transition metal salts and transition metal complexes,
   is produced and press-molded to form a recessed tablet in such a manner that the bleaching agent a) is present, separately from components b) and c), in a separate phase of the washing or cleaning agent, characterized in that the bleach activator b) is used in particulate form and the bleach activator particles have, relative to the total weight thereof, a content of bleach activator of above 80 wt. %.

After press-molding, the washing and cleaning agent moldings exhibit elevated stability. The breaking strength of cylindrical moldings may be determined by measuring the diametral fracture stress parameter, which may be determined according to—

$$σ = \frac{2 P}{π Dt}$$

σ here denotes diametral fracture stress (DFS) in Pa, P is the force in N which gives rise to the pressure exerted on the molding which causes fracture of the molding, D is the diameter of the molding in meters and t is the height of the molding.

In a further preferred embodiment, the bi- or multiphase washing or cleaning agents according to the invention assume the form of injection-molded dispensing units with two or more compartments which are separate from one another.

Injection molding here denotes forming of a molding composition in such a manner that the composition held in a cylinder for more than one injection molding operation is plasticized by exposure to heat and flows under pressure through a nozzle into the cavity of a tool which has previously been closed. The method is primarily used with non-curable molding compositions which solidify in the tool by cooling. Injection molding is a very economical modern method of producing objects formed without machining and is particularly suitable for automated mass production. In practice, the thermoplastic molding compositions (powders, chips, cubes, pastes etc.) are heated until they liquefy (up to 180° C.) and then injected under elevated pressure (up to 140 MPa) into closed, preferably water-cooled, mold cavities which consist of two parts, namely the cavity plate (formerly female mold) and core (formerly male mold), where the cool and solidify. Both plunger and screw injection molding machines may be used. Suitable molding compositions (injection molding compositions) are water-soluble polymers such as for example cellulose ethers, pectins, polyethylene glycols, polyvinyl alcohols, polyvinyl pyrrolidones, alginates, gelatins or starch.

In a third preferred embodiment, the bi- or multiphase washing or cleaning agents according to the invention assume the form of film pouches with two or more compartments which are separate from one another.

The film pouches are preferably obtained by thermoforming a film-like shell material. Thermoforming here preferably proceeds by placing the shell material over a receiving recess located in a female mold forming the thermoforming plane and then conforming the shell material to this receiving recess under the action of pressure and/or vacuum. Before or during conforming, the shell material may here be pretreated by the action of heat and/or solvent and/or conditioning under relative atmospheric humidity values and/or temperatures which differ from ambient conditions. The action of pressure may be applied by two parts of a tool, which behave as the positive and negative to one another and deform a film introduced between these tools when pressed together. Suitable pressing forces are, however, also the action of compressed air and/or the intrinsic weight of the film and/or the intrinsic weight of an active substance placed on the upper side of the film.

Suitable film materials include water-soluble polymers such as cellulose ethers, pectins, polyethylene glycols, polyvinyl alcohols, polyvinyl pyrrolidones, alginates, gelatins or starch.

The present application furthermore provides a method of cleaning dishes in a dishwashing machine using automatic dishwashing agents according to the invention, the automatic dishwashing agents preferably being dispensed into the interior of a dishwashing machine during the performance of a dishwashing program, before the start of the main washing cycle or in the course of the main washing cycle. Dispensing or introduction of the agent according to the invention into the interior of the dishwashing machine may proceed manually, but the agent is preferably dispensed into the interior of the dishwashing machine by means of the dispensing chamber of the dishwashing machine. Preferably, no additional water softener and no additional rinse aid is dispensed into the interior of the dishwashing machine in the course of the cleaning method. The present application also provides a kit for a dishwashing machine comprising—
a) an automatic dishwashing agent according to the invention;
b) instructions which instruct the consumer to use the automatic dishwashing agent without addition of a rinse aid and/or a water-softening salt.

The automatic dishwashing agents according to the invention exhibit their advantageous cleaning characteristics in particular in low temperature cleaning methods. Preferred dishwashing methods using agents according to the invention are accordingly characterized in that said methods are carried out at temperatures of up to 55° C., preferably up to 50° C.

As described above, agents according to the invention provide improved cleaning performance on bleachable soiling compared to conventional automatic dishwashing agents. The present application also provides for the use of automatic dishwashing agents according to the invention for improving bleaching performance in automatic dishwashing, in particular for removing tea stains.

### EXAMPLES

Soiled dishes were subjected to automatic cleaning in a dishwashing machine (Miele G 698) at a water hardness of 21 German hardness degrees and a temperature of 50° C., with in each case 21 g of the automatic dishwashing agents listed in the following table being used in the form of biphasic tablets.

| | | Comparison 1 | Invention 1 |
|---|---|---|---|
| | Ingredient | [wt. %] | [wt. %] |
| Phase [1] | Sodium percarbonate | 15 | 15 |
| Phase [2] | TAED | 3.9* | 3** |
| | Mn-Me₃-TACN complex | 0.05 | 0.05 |
| Phase [1] | Potassium tripolyphosphate | 30 | 30 |
| and/or [2] | Sodium carbonate | 12 | 12 |
| | HEDP | 2 | 2 |
| | Anionic copolymer | 20 | 20 |
| | Nonionic surfactant | 5 | 5 |
| | Protease preparation | 1.5 | 1.5 |
| | Amylase preparation | 1.5 | 1.5 |
| | Misc. | Ad 100 | Ad 100 |

| | | |
|---|---|---|
| Tea cleaning | 5.0 | 6.5 |

*Bleach activator granules with a TAED content of 78 wt. %
**Particulate bleach activator with a TAED content of above 97 wt. %

Tea cleaning by the automatic dishwashing agents was evaluated using the IKW method (tea cleaning evaluation scale: 10=no staining to 0=severe staining).

The stated values are mean values from cleaning tests which were carried out immediately after production of the dishwashing agent tablets and after 4 weeks' storage.

We claim:

1. Bi- or multiphase washing or cleaning agent comprising:
a) a bleaching agent,
b) a bleach activator, and
c) a bleach catalyst chosen from bleach-boosting transition metal salts and transition metal complexes,
wherein bleaching agent a) is present and separated from components b) and c) in a separate phase of the washing or cleaning agent, wherein bleach activator b) is in particulate form and has, relative to total weight of the particulate, a bleach activator content of 80 wt. % or greater.

2. Bi- or multiphase washing or cleaning agent according to claim 1, wherein the bleaching agent a) is an oxygen bleaching agent.

3. Bi- or multiphase washing or cleaning agent according to claim 1, wherein the amount of bleaching agent a), based on total weight of the washing or cleaning agent, is from 2 to 30 wt. %.

4. Bi- or multiphase washing or cleaning agent according to claim 1, wherein bleach activator b) is an acetylated amine.

5. Bi- or multiphase washing or cleaning agent according to claim 1, wherein the amount of bleach activator b), based on total weight of the washing or cleaning agent, is from 0.1 to 10 wt. %.

6. Bi- or multiphase washing or cleaning agent according to claim 1, wherein bleach activator b) is in the form of bleach activator granules having, based on total weight of the granule, bleach activator in an amount of 85 wt. % or greater.

7. Bi- or multiphase washing or cleaning agent according to claim 1, wherein bleach activator b) is in the form of bleach activator granules having, based on total weight of the granule, less than 20 wt. % of a polymeric granulation auxiliary.

8. Bi- or multiphase washing or cleaning agent according to claim 1, wherein bleach activator b) is in the form of bleach activator granules having, based on total weight of the granule, less than 20 wt. % of stabilizing additives.

9. Bi- or multiphase washing or cleaning agent according to claim 1, wherein bleach catalyst c) is a complex of manganese.

10. Bi- or multiphase washing or cleaning agent according to claim 1, wherein bleach catalyst c) is present in an amount of 0.001 to 3.0 wt. %, based on total weight of the washing or cleaning agent.

11. Bi- or multiphase washing or cleaning agent according to claim 1 further comprising a phosphonate present together with bleaching agent a) in one phase of the washing or cleaning agent.

12. Bi- or multiphase washing or cleaning agent according to claim 1, wherein the washing or cleaning agent is in the form of a bi- or multilayer, tablet.

13. Bi- or multiphase washing or cleaning agent according to claim 1, wherein the washing or cleaning agent is in the form of an injection-molded dispensing unit having two or more compartments separate from one another.

14. Method of cleaning dishes comprising washing dishes in an automatic dishwashing machine with a washing or cleaning agent according to claim 1.

15. Method according to claim 14, wherein no additional water softener and no additional rinse aid is dispensed into the interior of the dishwashing machine during the wash.
